(19) United States
(12) Patent Application Publication
(10) Pub. No.: US 2007/0239715 A1
(43) Pub. Date: Oct. 11, 2007

(54) Managing content objects having multiple applicable retention periods

(75) Inventor: Tod DeBie, Costa Mesa, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(73) Assignee: FileNet Corporation

(21) Appl. No.: 11/401,994

(22) Filed: Apr. 11, 2006

(51) Int. Cl. G06F 17/30

(52) U.S. Cl. 707/6

(57) ABSTRACT

A content management system and process that determines how long a content object should be retained. The system may include a content objects storage system configured to store content object information relating to a content object. It may also have a retention rules storage system configured to store retention rules that each include an attribute that the content object information may have and retention information indicating how long a content object having content object information with that attribute should be retained. It may also include a processing system and process that is configured to identify two or more retention rules within the retention rules storage system, each with an attribute that the content object information has, and determine the longest retention period indicated by the retention information associated with the identified retention rules.

### BACKGROUND

1. Field

Content management systems and processes and, more specifically, content management systems and processes that determine how long content objects should be retained.

2. Description of Related Art

Content objects often need to be managed, such as documents or records relating to claims, transactions, designs, safety, maintenance, and communications. Computers are often used as part of the management process.

Computerized content management systems often provide a variety of functions. One common function is to determine how long the managed content objects should be retained. Many systems do this by allowing the user to enter a default retention period for the entire set of content objects. Some of these systems also allow the user to enter one or more override retention periods and the criteria that a content object must meet to be subject to one of these override retention periods.

The content or nature of some content objects, however, may cause them to be subject to several different retention policies, some of which may involve inconsistent retention periods. The systems which are known have had difficulty easily dealing with this complexity. This has often caused the user to retain large volumes of content objects for a long period, even when many of these content objects did not need to have been retained for so long.

### SUMMARY

A content management system may determine how long a content object should be retained. The system may include a content objects storage system configured to store content object information relating to the content object. The system may also include a retention rules storage system configured to store retention rules that each include an attribute that the content object information may have and retention information indicating how long a content object having content object information with that attribute should be retained. The system may also include a processing system that may be configured to identify two or more retention rules within the retention rules storage system, each with an attribute that the content object information has, and determine the longest retention period indicated by the retention information associated with the identified retention rules.

The content objects storage system may be configured to store content object information that includes a property of the content object and at least two values for that property. The retention rules storage system may be configured to store retention rules that each include a property of the content object that the content object information may have, a value which that property in the content object information may have, and retention information indicating how long a content object having content object information with that property and value should be retained. The processing system may be configured to identify one retention rule within the retention rules storage system that has a property and a value for that property that matches the property and one of the values for that property in the content object information. The processing system may also be configured to identify another retention rule within the retention rules system that has a property and a value for that property that matches the property and another of the values for that property in the content object information.

The content objects storage system may be configured to store content object information that includes at least two properties of the content object and at least one value for each. The processing system may be configured to identify one retention rule within the retention rules system that has a property and a value for that property that matches one of the properties and one value for that property in the content object information. The processing system may be configured to identify another retention rule within the retention rules system that has a property and a value for that property that matches another of the properties and one value for that other property in the content object information.

The content objects storage system may be configured to store content object information that includes text of the content object. The retention rules storage system may be configured to store retention rules that each may include text that the text of the content object in the content object information may have and retention information indicating how long a content object having content object information with that text should be retained. The processing system may be configured to search the text of a content object as part of the identification process. The processing system may be configured to utilize fuzzy logic when determining whether the text of a content object in the content object information has the text specified by a retention rule.

The content objects storage system may be configured to store content object information relating to a plurality of content objects. The processing system may be configured to determine the longest retention period for each of the plurality of content objects.

The retention rules storage system may be configured to store retention information that includes a date, an event, and/or a period of time after an event beyond which a content object need not be retained.

The content object may be a single object or a set of objects.

The processing system may be configured to associate the determined longest retention period with the content object information.

Related processes may be employed. Computer-readable media may contain programming instructions which, when loaded in a computer system, cause the computer system to implement one or more of these related processes.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

FIG. 1 is a block diagram of a content management system that determines how long content objects should be retained.

FIG. 2 sets forth information about an insurance claim that may be stored in the content objects storage system shown in FIG. 1 and emphasizes attributes of the claim that match attributes referenced by the retention rules shown in FIG. 3.

FIG. 3 sets forth retention rules that may be stored in the retention rules storage system shown in FIG. 1 and emphasizes attributes referenced by the rules that match attributes of the claim shown in FIG. 2.

FIG. 4 is a flow diagram of a content objects management process that determines how long a content object should be retained.

### DETAILED DESCRIPTION OF ILLUSTRATIVE EMBODIMENTS

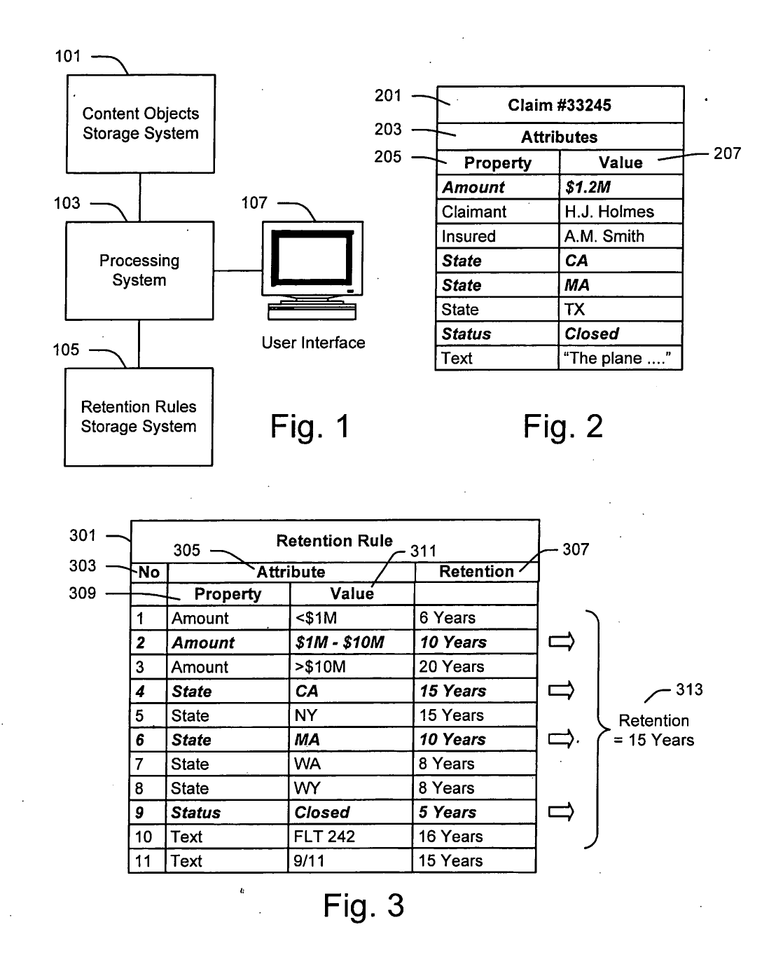

FIG. 1 is a block diagram of a content management system that determines how long content objects should be maintained.

As shown in FIG. 1, a content management system may include a content objects storage system 101, a processing system 103, a retention rules storage system 105, and a user interface 107.

The content management system (“CMS”) may be any type of content management system. It may consist of or include a records management system (“RMS”), a document management (“DMS”), and/or a content storage system (“CSS”)

RMSs may be used to identify, classify, and archive content objects that are determined to be legal records that need to be maintained as information about, and evidence of, business activities and transactions. Not all content objects in a CMS may end up being identified, or “declared”, as a record. Records may be electronic or physical objects, so RMSs may not necessarily store all records electronically, but instead maintain references to physical records in some cases. RMSs control the lifetime of such records, enforcing their retention or destruction in compliance with well-defined policies based on complex regulatory and legal constraints. One example of a legal constraint is a court order to retain documents pertaining to an on-going court case, regardless of regular retention policies which would ordinarily call for the destruction of some or all of those records.

A DMS may store and manage images of paper documents, as well as electronic documents such as word processor files or spreadsheets. DMSs may associate attributes with documents that describe those documents, such as author, title, subject, or creation date. Some or all of these attributes may be used in a search expression when searching for a particular document. DMSs may also include facilities for managing the retention of documents, that is, how long they must be maintained and when they may or must be destroyed. They may provide facilities for tracking versions of documents and enforce security of documents through various forms of access control such as access controls lists.

Content storage systems may lack many management functions, such as version control or access control. Content storage systems may primarily just store information; however, they may also provide simple retention management capabilities.

The content objects storage system 101 may be configured to store information that relates to one or more content objects. A content object may be of any type, such as a physical document, graphic, film, video, CD, DVD, or a set of them. A content object may also be an electronic file, such as a music file, text file, graphics file, video file, or multimedia file, or a set of such files. The electronic files may be in any form, including in binary or ASCII.

The content objects storage system 101 may be configured to store any type of information relating to the content objects, such as metadata describing one or more attributes of each content object. The attributes may be in any format. In one embodiment, the content objects storage system 101 may be configured to allow one or more of the attributes to be specified as a property of the content object and as one or more values for that property.

The content objects storage system 101 may be configured so that the information relating to the content objects includes all or portions of the content object itself in any format, such as in the format of an image of the content object and/or text that is contained within the content object. In some embodiments, the content objects storage system 101 may be configured to store information relating to the content objects that consists only of content objects or portions of content objects themselves, with no metadata about the content objects, except, in some embodiments, retention information about the content objects.

The content objects storage system 101 may be configured to store the content object information in any format using any type of organizational structure.

The retention rules storage system 105 may be configured to store retention rules. Each retention rule may include an attribute that the content object information in the content objects storage system 101 may have.

The retention rules storage system 105 may be configured to store the attribute of retention rules in any format, including in the form of a property that the content object information may have and a value which that property in the content object information may have. In this embodiment, the retention rules storage system 105 may be configured to store more than one retention rule for the same property of the content object information. The retention rules storage system 105 may be configured to store different values for retention rules that specify the same property. The retention rules storage system 105 may be configured to store retention rules that target different properties of the content object information, each with their own value.

The retention rules storage system 105 may be configured to allow one or more attributes to be specified in the format of an expression, such as a Boolean logic expression. In this instance, each attribute may represent a logical combination of values that may be found in the content object information. The retention rules storage system 105 may be configured to permit two or more of the values that make up a single expression to be found within the same property of the content object information and/or within different properties of the content object information.

The retention rules storage system 105 may be configured to allow each retention rule to include retention information that indicates how long a content object with content object information having its attribute should be retained. That length may be absolute in nature, such as a specific date. It may also be relative to other information. For example, the length may be an identified event beyond which the content object no longer needs to be retained. The event of transferring the content object elsewhere for handling is an example. The length may instead be a time period after an event beyond which the content object no longer needs to be retained. An example is 5 years after a file to which the content object refers is closed.

The retention rules storage system 105 may be configured to store the retention rules in any format using any type of organizational structure.

The content objects storage system 101 and the retention rules storage system 105 may be any type of storage system. Each may include one or more RAMs, ROMs, hard drives, CDs, DVDs, tapes, and/or memory cards, organized and configured in any manner. Each of these storage systems may be at a single location or may be distributed over multiple locations. The storage systems may share the same hardware or may be partially or totally independent from one another.

The user interface 107 may be any type of user interface. It may include one or more displays, keyboards, mice, touch screens, printers, and/or interfaces to other systems. The user interface 107 may be configured to receive input from the user and to provide output to the user to facilitate the functions and operations discussed herein. These may include the entry of all or portions of the content object information in the content objects storage system 101, the entry of all or portions of the retention rules in the retention rules storage system 105, the loading and/or operation of computer software that causes the content management system to perform one or more of the operations described herein, and/or the delivery of information and reports concerning the content objects, including information about how long one or more of the content objects should be retained.

The processing system 103 may be configured to communicate with the content objects storage system 101, the retention rules storage system 105, and/or the user interface 107. The processing system 103 may be configured to perform one or more of the functions and operations that are described herein. Hardware, firmware and/or software may be used as part of the configuration. Computer-readable media, such as one or more CDs, DVDs, floppy disks, tapes, memory sticks, may contain programming instructions which, when loaded into the processing system 103, cause the processing system 103 to perform all or portions of the functions and operations that are described herein.

The processing system may be any type of processing system, including a personal computer, a server computer, a wide, local, or personal area network, and/or any other type of processing system. The processing system 103 may be at a single location or may be distributed across multiple locations. It may be dedicated to the functions and operations that are described herein or may perform additional functions and operations.

FIG. 2 sets forth information about an insurance claim that may be stored in the content objects storage system shown in FIG. 1 and emphasizes attributes of the claim that match attributes referenced by the retention rules shown in FIG. 3. This information may relate to a single content object, in this case an insurance claim. Information about other content objects of a similar type may also be stored in the content object storage system 101 shown in FIG. 1 as part of the content object information.

As shown in FIG. 2, the claim may include a claim number 201 and one or more attributes of the claim. Each attribute 203 may include a property 205 of the claim and an associated value 207 for that property.

For example, one property 205 may be an Amount having a value that is $1.2M. In this particular case, the $1.2M value may represent the amount of the claim. Other properties 205 may be a Claimant with a value of H. J. Holmes; an Insured with a value of A. M. Smith; three States that the claim involves with values of CA, MA, and TX, respectively; a Status of the claim with a value of Closed; and Text in the claim with a value of “The plane . . . . ”

This example of content object information relating to a content object illustrates several characteristics that the content object information may have. For example, it illustrates that the information about the content object may be categorized into several properties with a value for each. It also illustrates that the content object information may have several values that are associated with the same property, such as the three instances of the State property.

This example also illustrates that textual information may be stored in the content objects storage system 101 as part of the content object information relating to the content object. This may include all or portions of the text of the content object.

The content object information that is stored in the content objects storage system 101 may be different from what is shown in FIG. 2. It may have attributes in a different format, different properties, different values for those properties, and/or may otherwise be in a different format and with a different structure.

FIG. 3 sets forth retention rules that may be stored in the retention rules storage system shown in FIG. 1 and emphasizes attributes referenced by the rules that match attributes of the claim shown in FIG. 2. As shown in FIG. 3, each retention rule 301 may include a rule number 303, an attribute 305 and retention information 307. Each attribute 305 may include a property 309 and a value 311.

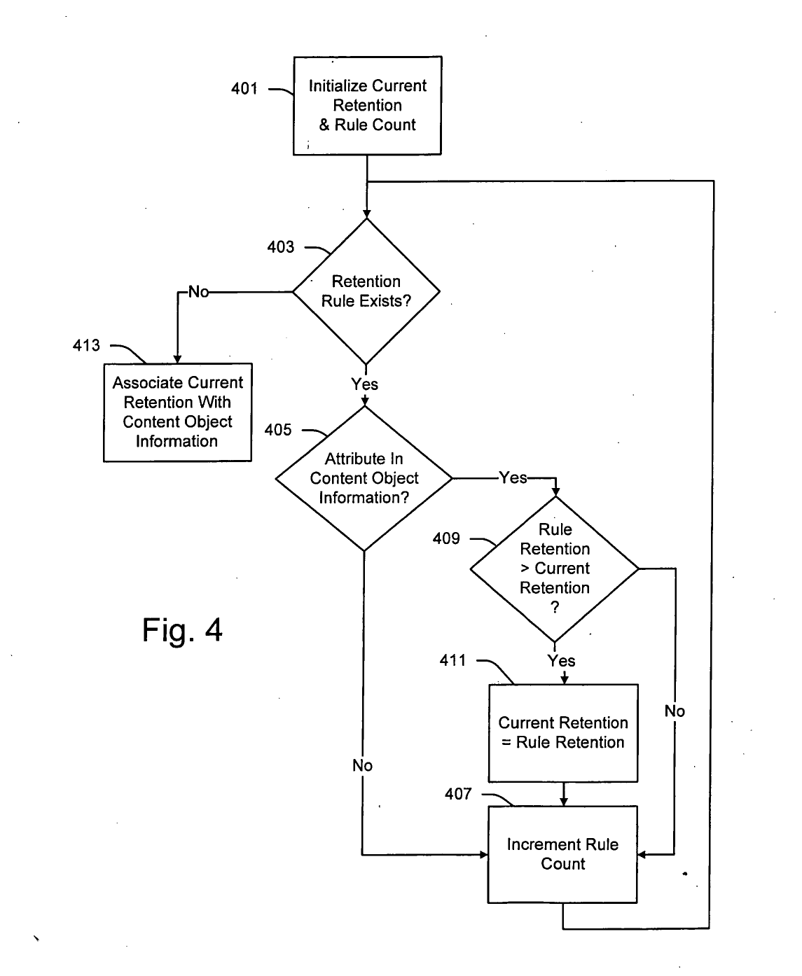

The rule number 303 of each retention rule may be included for tracking and processing purposes. One use of the rule number 303 will be discussed below in connection with FIG. 4.

The attribute 305 referenced by each retention rule may specify an attribute that the content object information relating to a particular content object that is stored in the content objects storage system 101 may have. The property 305 may specify the particular property of the content object to be examined, while the value 311 may specify the value that this examined property may have.

One or more attributes 305 may be specified in the format of an expression, such as a Boolean logic expression. In this instance, an attribute may represent a logical combination of values that may be found in the content object information. When an attribute is represented by a property 309 and an associated value 311 for that property, the logical expression may include two or more values that the content object information may have. Two or more of these values may be within the same property of the content object information or within different properties of the content object information.

Rule No. 2 references an example of an attribute that may be specified in the format of a Boolean logic expression. The expression may be “Amount>=$1M AND Amount <=$10M”.

Similarly, rule Nos. 4 and 5 could have been combined into a single rule with the single attribute being specified as the Boolean logic expression “State=CA OR State =NY.” Rules 7 and 8 could similarly have been combined into a single rule with the single attribute being specified as the expression “State=WA OR State=WY”.

The retention information 307 of each rule may specify how long a content object should be retained when its content object information has the tested attribute 305, in this case the tested property 309 with its associated value 311. This length may be specified by a specific date, the occurrence of a specified event, by a time period after a specified event, and/or by any other length-indicating information.

The attribute 305 and retention information 307 referenced in a retention rule 301 may in an alternate embodiment collectively be represented by other rule representations utilizing a single Boolean expression. For example, Rule No. 2 may in an alternate embodiment be represented by the expression “if (Amount>=$1M AND Amount<=$10M) Retention=10 Years”.

Boolean expressions could be even more complex. For example, in an alternate embodiment, Retention Rules 2 and 6 could be combined into the single retention rule “if (Amount>=$1M AND Amount<=$10M) OR State=MA) Retention=10 Years”.

The bolded and italicized entries in the tables shown in FIGS. 2 and 3 reflect matches between properties and their associated values in the retention rules shown in FIG. 3 and in the content object information that is shown in FIG. 2. For example, the retention rule with the property Amount and value $1M-$10M in FIG. 3 has been bolded and italicized because that same property and matching value appear in the content object information shown in FIG. 2. The same holds true for the property State with the value CA, the property State with the value MA, and the property Status with the value Closed.

These matches illustrate the possibility that a single property within a content object, i.e., the State property in this example, may have multiple values within the content object information (shown in FIG. 2), and that more than one of these values may match a retention rule (shown in FIG. 3). It also illustrates that values of different properties (shown in FIG. 2) may similarly match different retention rules (shown in FIG. 3).

A further point illustrated by FIGS. 2 and 3 is that content object information about a single content object may match two or more retention rules that collectively specify different retention periods. In this case, the content object information that is shown in FIG. 2 matches retention rule numbers 2, 4, 6 & 9 in FIG. 3, which have retention periods of 10 years, 15 years, 10 years, and 5 years, respectively. As will be seen below in connection with the discussion of FIG. 4, the processing system 103 may be configured to identify the retention period that is longest from among these matching rules and to associate this longest retention period with the content object information that is shown in FIG. 2. This may result in a determination that the content object information that is shown in FIG. 2 should have a retention of 15 years, as reflected by a Retention=15 Years statement 313 in FIG. 3.

Retention rule numbers 10 and 11 in FIG. 3 illustrate another feature that the retention rules may include. Specifically, they illustrate that a retention rule may seek to examine text of the content object when that text is included in the content object information. In this case, rule number 10 is configured to test whether the content object text contains the phrase “FLT 242”, while rule number 11 is configured to test whether the text contains the phrase “9/11”.

The content and structure of the retention rules that are stored within the retention rules storage system 105 may be different from what has been illustrated.

FIG. 4 is a flow diagram of a content objects management process that determines how long a content object should be retained. This process may be used in conjunction with the content management system shown in FIG. 1 and the tables shown in FIGS. 2 and 3. It may also be used in conjunction with other content management systems and tables. Similarly, the content management system shown in FIG. 1 and the tables shown in FIGS. 2 and 3 may be used in conjunction with other processes.

As shown in FIG. 4, a Current Retention and a Rule Count may be initialized, as reflected by an Initialize Current Retention and Rule Count step 401.

The Current Retention may represent the value the system is tracking for how long a particular content object should be retained. In some systems, this value may be initialized to a default value that should be applied to all content objects in the absence of a contrary rule. An example of such a value is 10 years. The Current Retention value may instead be initialized to other values, such as 6 years, indefinitely or zero.

The Rule Count may represent a pointer to the retention rule number 303 that is being evaluated. In some systems, the Rule Count may be initialized to “1.”

A determination may next be made as to whether the Rule Count specifies a rule number 303 that actually exists. This is reflected by a Retention Rule Exists? decision step 403. Unless no retention rules have been entered in the retention rules storage system 105, a retention rule may exist at this stage of the process with this initial value. This may cause the process to next evaluate the content object information that relates to a content object that is stored in the content objects storage system 101 to determine whether this content object information matches the attribute 305 referenced by the rule number 303 that is specified by the Rule Count. This is reflected by an Attribute in Content object Information? decision step 405.

The process that may be followed to make the decision 405 may vary depending upon the format of the attribute 305 that is stored in the retention rules storage system 105 and the content object information that is stored in the content objects storage system 101.

In connection with the first rule that is illustrated in FIG. 3 and the content object that is illustrated in FIG. 2, the content object information in FIG. 2 may be reviewed to determine whether it contains an Amount property with a value of less than $1M. In this instance, it does not. The process may therefore increment the Rule Count to the next rule number 303, as reflected by an Increment Rule Count step 407.

The process may then test the content object information in FIG. 2 to determine whether it has an Amount property that has a value within the range of $1M-$10M. In this instance, there may be a match. The process may proceed from the Attribute in Content object Information? decision step 405 to determine whether the retention period that is specified in the matching rule is greater than the Current Retention, as reflected by a Rule Retention>Current Retention? decision step 409. If the retention period for the currently matching rule is greater than the Current Retention, the Current Retention may be replaced by the greater retention period of the matching rule, as reflected by a Current Retention=Rule Retention step 411. The Rule Count may be again incremented, as reflected by the Increment Rule Count step 407, and the process may proceed with the Retention Rule Exists? decision step 403 and recycle. If the Rule Retention is not greater than the Current Retention, on the other hand, the process may go directly to the Increment Rule Count step 407.

The process may continue to recycle until all of the retention rules have been tested. Once they have, the Rule Count may exceed any rule number 303 that is in the rules retention storage system 105. This may cause the Retention Rule Exists? decision step 403 to transfer control to an Associate Current Retention With Content Object Information step 413. During this step, the processing system 103 may associate the Current Retention value with the content object information about the content object that has been examined. This association may include storing the Current Retention value as part of the content object information, storing it in a separate data storage area that is associated with the content object information, and/or including it in a content object retention report.

As should now be apparent, the net effect of the process shown in FIG. 4 may be to identify all of the retention rules that apply to content object information about a particular content object and to equate the retention period for that particular content object to the longest of the retention periods that are associated with each matching retention rule. The process also illustrates that different retention periods may be associated with different values of a single property for a content object, as well as with particular values of different properties for the content object. It also illustrates that textual information in a content object may similarly be tested against a retention rule, such as the retention rule numbers 10 and 11 shown in FIG. 3.

Although not shown, other types of content object information relating to the content object may also be tested against a retention rule, including whether the content object information includes a word in an audio file (which may utilize voice recognition) and/or whether it includes an image in a video file (which may utilize pattern recognition).

The process that has been described in connection with FIG. 4 may be repeated in connection with each of the other content objects about which the content object information in the content objects storage system 101 may relate. The processing system 103 may be configured to do this automatically in connection with content object information relating to an entire set of content objects, in connection with content object information relating to only a subset of these content objects, such as only those content objects that are being considered for disposal, or in connection with a set of content objects specified by a user. It may also or instead be configured to perform one or more steps of this process in response to a directive from a user.

Other sequences of steps may also or instead be followed. For example, instead of testing for the presence of each retention rule 301 in the content object information relating to a content object, the process may run the values for all properties of the content object information through a graph structure that in essence only evaluates the rules for which the content object information has values. For example, the process may consider rule no. 7 for State=WA and rule no. 8 for State=WY when the content object information has the values WA and WY for State, but may ignore rule nos. 4-6 when the content object information lacks the values CA, NY & MA for State.

A business rules engine may be used to aid in the evaluation of the rules, such as a business rules engine from ILOG or Fair Isaacs.

It may not always be possible to determine the longest retention period in connection with a content object that matches a retention rule that specifies a retention period that is based on the occurrence of an event that has not yet taken place. In this circumstance, the step of determining the longest retention period may return a value signifying that the longest retention period cannot currently be determined. In another embodiment, the step may return the longest retention period that is known at the time of the determining step, together with the retention information about the period whose actual date is presently unknown. In either case, the retention period may be set to indefinitely until the event occurs.

The components, steps, features, objects, benefits and advantages that have been discussed are merely illustrative. None of them, nor the discussions relating to them, are intended to limit the scope of protection in any way. Numerous other embodiments are also contemplated, including embodiments that have fewer, additional, and/or different components, steps, features, objects, benefits and advantages. The components and steps may also be arranged and ordered differently.

In short, the scope of protection is limited solely by the claims that now follow. That scope is intended to be as broad as is reasonably consistent with the language that is used in the claims and to encompass all structural and functional equivalents. Nothing that has been stated or illustrated is intended to cause a dedication of any component, step, feature, object, benefit, advantage, or equivalent to the public, regardless of whether it is recited in the claims.

The phrase “means for” when used in a claim embraces the corresponding structure and materials that have been described and their equivalents. Similarly, the phrase “step for” when used in a claim embraces the corresponding acts that have been described and their equivalents. The absence of these phrases means that the claim is not limited to any corresponding structures, materials, or acts.

I claim:

1. A content management system that determines how long a content object should be retained, comprising:
a content objects storage system configured to store content object information relating to the content object;
a retention rules storage system configured to store retention rules that each include an attribute that the content object information may have and retention information indicating how long a content object having content object information with that attribute should be retained; and
a processing system configured to:
identify two or more retention rules within the retention rules storage system, each with an attribute that the content object information has; and
determine the longest retention period indicated by the retention information associated with the identified retention rules.

2. The content management system of claim 1 wherein:
the content objects storage system is configured to store content object information that includes a property of the content object and at least two values for that property;
the retention rules storage system is configured to store retention rules that each include a property of the content object that the content object information may have, a value which that property in the content object information may have, and retention information indicating how long a content object having content object information with that property and value should be retained; and
the processing system is configured to identify:
one retention rule within the retention rules storage system that has a property and a value for that property that matches the property and one of the values for that property in the content object information; and
another retention rule within the retention rules system that has a property and a value for that property that matches the property and another of the values for that property in the content object information.

3. The content management system of claim 1 wherein:
the content objects storage system is configured to store content object information that includes at least two properties of the content object and at least one value for each; and
the processing system is configured to identify:
one retention rule within the retention rules system that has a property and a value for that property that matches one of the properties and one value for that property in the content object information; and
another retention rule within the retention rules system that has a property and a value for that property that matches another of the properties and one value for that other property in the content object information.

4. The content management system of claim 1 wherein:
the content objects storage system is configured to store content object information that includes text of the content object;
the retention rules storage system is configured to store retention rules that each may include text that the text of the content object in the content object information may have and retention information indicating how long a content object having content object information with that text should be retained; and
the processing system is configured to search the text of a content object as part of the identification process.

5. The content management system of claim 4 wherein the processing system is configured to utilize fuzzy logic when determining whether the text of a content object in the content object information has the text specified by a retention rule.

6. The content management system of claim 1 wherein:
the content objects storage system is configured to store content object information relating to a plurality of content objects; and
the processing system is configured to determine the longest retention period for each of the plurality of content objects.

7. The content management system of claim 1 wherein the retention rules storage system is configured to store retention information that includes a date beyond which a content object need not be retained.

8. The content management system of claim 1 wherein the retention rules storage system is configured to store retention information that includes an event beyond which a content object need not be retained.

9. The content management system of claim 1 wherein the retention rules storage system is configured to store retention information that includes a period of time after an event beyond which a content object need not be retained.

10. The content management system of claim 1 wherein the content object is a single object.

11. The content management system of claim 1 wherein the content object is representative of a set of objects.

12. The content management system of claim 1 wherein the processing system is configured to associate the determined longest retention period with the content object information.

13. The content management system of claim 1 wherein the retention rules storage system is configured to store retention rules that may include a Boolean expression, referencing one or more attributes, that the content object information may satisfy.

14. A content objects management process that determines how long a content object should be retained, comprising:
identifying two or more retention rules, each having an attribute that content object information relating to the content object has; and
determining the longest retention period indicated by retention information associated with the identified retention rules.

15. The content objects management process of claim 14 wherein the identifying includes:
identifying one retention rule that has a property of a content object and a value for that property that matches a property of the content object and a value for that property in the content object information; and
identifying another retention rule that has the same property of the content object but a different value of that property that matches the same property of the content object but a different value for that property in the content object information.

16. The content objects management process of claim 14 wherein the identifying includes:
identifying one retention rule that has a property of a content object and a value for that property that matches a property of the content object and a value for that property in the content object information; and
identifying another retention rule that has a different property of a content object and a value for that different property that matches a different property of the content object and a value for that different property in the content object information.

17. The content objects management process of claim 14 wherein the content object information includes text of the content object and the identifying includes searching the text of the content object information.

18. The content objects management process of claim 17 wherein the searching utilizes fuzzy logic.

19. The content objects management process of claim 14 wherein the identifying and the determining are performed repeatedly to determine how long each of a plurality of content objects should be retained.

20. The content objects management process of claim 14 wherein the determining includes determining a date beyond which a content object need not be retained.

21. The content objects management process of claim 14 wherein the determining includes determining an event beyond which a content object need not be retained.

22. The content objects management process of claim 14 wherein the determining includes determining a period of time after an event beyond which a content object need not be retained.

23. The content objects management process of claim 14 wherein the content object is a single object.

24. The content objects management process of claim 14 wherein the content object is representative of a set of objects.

25. The content objects management process of claim 14 further comprising associating the determined longest retention period with the content object information.

26. The content objects management process of claim 14 wherein the identifying includes identifying a retention rule that has a Boolean expression that is satisfied by the content object information.

27. Computer-readable media containing programming instructions which, when loaded in a computer system, cause the computer system to determine how long a content object should be retained by:
identifying two or more retention rules, each having an attribute that content object information relating to the content object has; and
determining the longest retention period indicated by retention information associated with the identified retention rules.
